(19) United States
(12) Patent Application Publication
(10) Pub. No.: US 2008/0067917 A1
(43) Pub. Date: Mar. 20, 2008

(54) DISPLAY

(76) Inventors: Masaaki Komatsu, Kodaira (JP); Hirotaka Sakuma, Hachioji (JP); Shin Imamura, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/776,058

(22) Filed: Jul. 11, 2007

(30) Foreign Application Priority Data
Sep. 14, 2006 (JP) 2006-248872

(51) Int. Cl. H01J 1/62; H01J 17/49

(52) U.S. Cl. 313/503; 313/582

(57) ABSTRACT

In order to improve luminescence life, color temperature, the linearity of luminous intensity, and colority that have not been solved by conventional methods, a thin panel display of electron beam excitation type includes a substrate including plural first electrodes parallel to each other, plural second electrodes parallel to each other that are orthogonal to the first electrodes, and electron emitters disposed in intersections of the first electrodes and the second electrodes, or near the intersections, and a faceplate on which phosphor layers are formed, in which, as the phosphor layers, blue emitting phosphor layers are used which contain CaMgSi₂O₆:Eu blue emitting phosphors that have 0.16° or less as full width at half maximum of an X-ray diffraction peak developing near a central peak of 29.8°.

### CLAIM OF PRIORITY

The present application claims priority from Japanese application JP 2006-248872 filed on Sep. 14, 2006, the content of which is hereby incorporated by reference into this application.

### FIELD OF THE INVENTION

The present invention relates to a display that includes substrates on which phosphor layers are formed, and electron emitters that emit electron beams to the phosphor layers, or discharge gas that radiates ultraviolet rays. More particularly, it relates to a display that employs, as phosphors constituting the phosphor layers, CaMgSi₂O₆:Eu blue emitting phosphors having 0.16° or less as full width at half maximum of X-ray diffraction peak developing near a central peak of 29.8°.

### BACKGROUND OF THE INVENTION

In an image information system, research and development on different types of displays is flourishing to meet various demands such as high definition, large screen, thin type, and low power consumption. As displays to meet the demands for thin type and low power consumption, research and development on thin panel displays of electron beam excitation type has been recently flourishing. The thin panel displays of electron beam excitation type are structured so that electron emitters corresponding to pixels (subpixels) are disposed on the rear side of an enclosed vacuum box and phosphor layers are disposed on the inside face of a front faceplate. They emit light by radiating electron beams of low accelerating voltages from about 0.1 to 10 kV to the phosphor layers to display images. In this case, since the electron density of electron beams radiated to the phosphor layers is as high as about 10 to 1000 times that of general cathode-ray tubes, the phosphor layers for the thin panel displays of electron beam excitation type are demanded to have low resistance so as not to cause saturation with electric charges. Furthermore, the characteristic of life under high electron density, and color balance after longtime radiation of electron beams must be excellent. Less luminescence saturation (low increase in luminous intensity with respect to irradiation current quantity) and the characteristic of high luminescence are also required.

The thin panel displays of electron beam excitation type have several systems, depending on electron emitters used. Displays that employ field-emission electron sources such as Spindt type electron source and carbon nanotube type electron source as electron emitters are referred to as field emission displays (FED). Other known displays include displays that employ surface conduction type electron source as electron emitters, and displays of MIM type (Metal-Insulator-Metal type electron source), BSD type (Ballistic Electron Surface-Emitting Display), and HEED type (High Efficiency Electroemission Device) that employ thin-film electron source employing hot electrons accelerated in electron acceleration layers. Hereinafter, these thin panel displays of electron beam excitation type will be collectively referred to as FED (in a broad sense).

So far, various developments have been made to realize long-life and high-linearity (high increase in luminous intensity with respect to irradiation current quantity) phosphor layers. In high-voltage-type FEDs, as described in J. Vac. Sci. Technol. A19(4) 2001, p 1083, ZnS:Ag blue light emitting phosphors are used. However, there are problems such as emitter pollution by sulfur, and the luminescence life and luminescence saturation of blue and green emitting phosphors. In low-voltage-type FEDs, as described in SID04, 19.4L, p 832, Y₂SiO₅:Ce blue emitting phosphors are used. However, there are problems such as low luminescence, and colority deterioration that the colority of blue emission shifts in white direction as a result of longtime electron beam radiation. On the other hand, as new blue emitting oxide phosphors, the results of evaluating the luminescence of CaMgSi₂O₆:Eu blue emitting phosphors by exciting electron beams of low accelerating voltages are described in Extended Abstract of the Fifth Int. Conf. of Display Phosphors 1999, p 317. However, the characteristics of CaMgSi₂O₆:Eu blue emitting phosphors such as long life and high linearity are not described, and the description of improving luminous intensity by enhancing crystallinity is lacking.

Recently, as described in JP-A No. 2003-197135, CaMgSi₂O₆:Eu blue emitting phosphors and ZnS:Ag blue emitting phosphors are combined to be used as blue emitting phosphor layers for FED. However, there is no example of CaMgSi₂O₆:Eu blue emitting phosphors with luminous intensity increased by enhancing crystallinity. Although not used as phosphors for FED, CaMgSi₂O₆:Eu blue emitting phosphors are used as phosphors for exciting vacuum-ultraviolet rays as described in JP-A No. 2002-332481 Asia Display/IDW’ 01, PHp1-7, p 1115. However, there is not yet an example that increases luminous intensity by enhancing crystallinity.

So far, various methods have been attempted to realize phosphor layers for FED having low resistance, long life, and high luminescence. However, not all the problems have been solved by these conventional methods. A new method is required to realize, particularly, long life and high linearity.

### SUMMARY OF THE INVENTION

Therefore, an object of the present invention is to improve the respective characteristics of the luminous intensity, luminescence life, linearity, and colority of the above-described conventional phosphor layers, and to provide a display having the characteristic of excellent luminescence life.

The above-described object is achieved by a display that includes a substrate including plural first electrodes parallel to each other, plural second electrodes parallel to each other that are orthogonal to the first electrodes, and electron emitters disposed in intersections of the first electrodes and the second electrodes, or near the intersections, and a faceplate on which phosphor layers are formed, wherein, as the phosphor layers, blue emitting phosphor layers are used which contain CaMgSi₂O₆:Eu blue emitting phosphors that have 0.16° or less as full width at half maximum of an X-ray diffraction peak developing near a central peak of 29.8°. The accelerating voltages of electron beams of the display in this case are in a range from 1 to 15 kV. It is desirable that the median diameter of the CaMgSi₂O₆:Eu blue emitting phosphors has a size that allows the performance of the phosphors to be fully delivered, and is suitable for printing coating. To satisfy a demand for such a median diameter of the phosphors, the median diameter of the CaMgSi₂O₆:Eu blue light emitting phosphors should be from about 5 to 8 μm.

At least one kind of an element selected from a group comprising IIa, IIb, and IVb families may be added to the CaMgSi₂O₆:Eu blue emitting phosphors. By adding these elements, luminous intensity and colority can be improved. Particularly, when the Sr element is added, the luminous intensity of CaMgSi₂O₆:Eu blue emitting phosphor can be increased. Proper addition amounts of the Sr element are from 1 to 10 wt. %. In a method of synthesizing phosphors by using flux, at least one kind of a trace impurity selected from a group comprising Ia and VIIb families, and rare-earth elements may be contained. Thus, higher-performance displays can be realized by the CaMgSi₂O₆:Eu blue emitting phosphors doped with various elements.

By making a weak reducing atmosphere in second heating as a method of manufacturing the CaMgSi₂O₆:Eu blue emitting phosphors, the crystallinity can be increased. Specifically, a carbon crucible is used, or H₂ concentration is made 0.5% or less in a N₂—H₂ reducing atmosphere. In the case of the CaMgSi₂O₆:Eu blue light emitting phosphors heated in the weak reducing atmosphere, in a luminescence spectrum at the time of excitation at 254 nm, the luminescence of Eu³⁺exists at 620 nm in an amount of about 1% with respect to blue luminescence peak intensity at 448 nm. The luminescence at 620 nm exerts no influence on colority and holds excellent crystallinity, and blue luminous intensity is sufficiently high. Therefore, an appropriate range of luminescence peak intensity at 620 nm is from 0.3 to 2% with respect to the blue luminescence peak intensity at 448 nm.

The CaMgSi2O6:Eu blue emitting phosphors produced by the present invention can be used in a plasma display panel. The above-described object can be achieved by a display having a plasma display panel that includes a front substrate and a rear substrate that are disposed in opposed relation, wherein plural display electrode pairs are disposed in parallel on the front substrate, and phosphor layers and plural address electrodes disposed in a direction intersecting with the display electrode pairs are disposed in parallel on the rear substrate, and wherein, as the phosphor layers, blue emitting phosphor layers are used which contain CaMgSi₂O₆:Eu blue emitting phosphors that have 0.16° or less as full width at half maximum of an X-ray diffraction peak developing near a central peak of 29.8°. In the case of the CaMgSi₂O₆:Eu blue light emitting phosphors synthesized in the weak reducing atmosphere, in a luminescence spectrum at the time of excitation at 254 nm, the luminescence of Eu³⁺ exists at 620 nm in an amount of about 1% with respect to blue luminescence peak intensity at 448 nm. By using such phosphors, a display having excellent luminescence life can be provided.

Since a display of the present invention employs blue emitting phosphor layers containing CaMgSi₂O₆:Eu blue emitting phosphors improved in crystallinity, the linearity of luminous intensity is excellent, long life is achieved, and luminescence characteristic and colority balance are excellent even after longtime driving.

### BRIEF DESCRIPTION OF THE DRAWINGS

FIG. 1 is a graph showing X-ray diffraction of phosphor of the present invention;

FIG. 2 is a graph showing X-ray diffraction of phosphor of the present invention;

FIG. 3 is a graph showing X-ray diffraction full width at half maximum of phosphor of the present invention;

FIG. 4 is a graph showing luminescence spectrum of phosphor of the present invention;

FIG. 5 is a picture showing a SEM image of phosphor of the present invention;

FIG. 6 is a graph showing relative luminous intensity of phosphor of the present invention;

FIG. 7 is a graph showing luminescent maintenance factors of phosphor of the present invention;

FIG. 8 is a schematic plan view of a display panel of a second embodiment of the present invention;

FIG. 9 is a schematic sectional view of a display panel of a second embodiment of the present invention;

FIGS. 10A, 10B, and 10C are schematic sectional views of a display panel of a second embodiment of the present invention;

FIG. 11 is a schematic diagram showing the whole structure of a display with Spindt type electron source of the present invention;

FIG. 12 is a schematic diagram showing the whole structure of a display with carbon nanotube type electron source of the present invention; and

FIG. 13 is a schematic diagram showing the whole structure of a plasma display panel of the present invention.

### DETAILED DESCRIPTION OF THE PREFERRED EMBODIMENTS

The following details a method of manufacturing phosphors used in a display of the present invention, and their properties such as X-ray diffraction and luminous intensity. Embodiments described below are examples of implementing the present invention, and will not restrain the present invention.

### First Embodiment

A description is made of a method of manufacturing CaMgSi₂O₆:Eu blue emitting phosphors used for the present invention. CaCO₃, MgCO₃, SiO₂, and EuCl₃ are used phosphor materials, and NH₄Cl is used as a flux. The quantities of the materials to be blended are as follows.
CaCO₃: 0.981 g
MgCO₃: 0.959 g
SiO₂: 1.322 g
EuCl₃: 0.074 g
NH₄Cl: 0.016 g

The materials are dry-blended in a mortar for about 30 minutes, and then packed in an alumina crucible and subjected to first heating in a muffle furnace at 600° C. and for three hours in an air atmosphere. The obtained first heated phosphor is taken out and lightly loosened, and then packed in a carbon crucible. Furthermore, the carbon crucible is put in a larger alumina crucible, and the carbon crucible with carbon particles packed in voids in the alumina crucible is subjected to second heating in the muffle furnace at 1150° C. for three hours in an air atmosphere. The obtained second heated phosphor is taken out and lightly loosened to obtain a desired CaMgSi₂O₆:Eu blue emitting phosphor.

In the second heating, the phosphor may also be synthesized in an N₂—H₂ reducing atmosphere. The first heated phosphor is packed in a quartz double crucible and subjected to second heating at 1150° C. in a tube furnace for three hours in an N₂—H₂ reducing atmosphere (H₂ concentration 0-3%). The obtained second heated phosphor is lightly loosened to obtain a desired CaMgSi₂O₆:Eu blue emitting phosphor.

Next, X-ray diffraction of CaMgSi₂O₆:Eu blue emitting phosphor is measured. Rigaku-manufactured RINT 2000 is used for the measurement. Measurement conditions are as follows.
X-radiation source: CuKα
Tube voltage: 40 kV
Tube current: 100 mA
Divergence slit width: ½ deg
Scattering slit width: ½ deg
Light receiving slit width: 0.15 mm
Scanning speed: 0.5 sec step-scan
Scanning Step: 0.02 deg

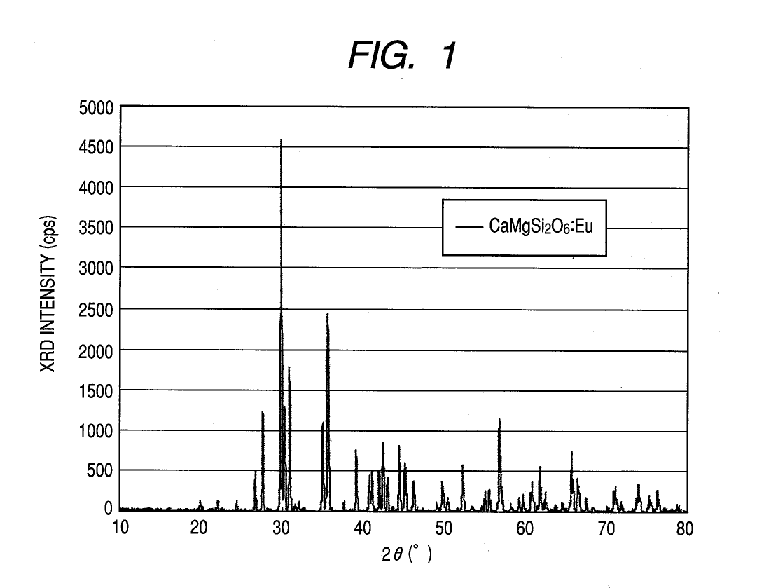

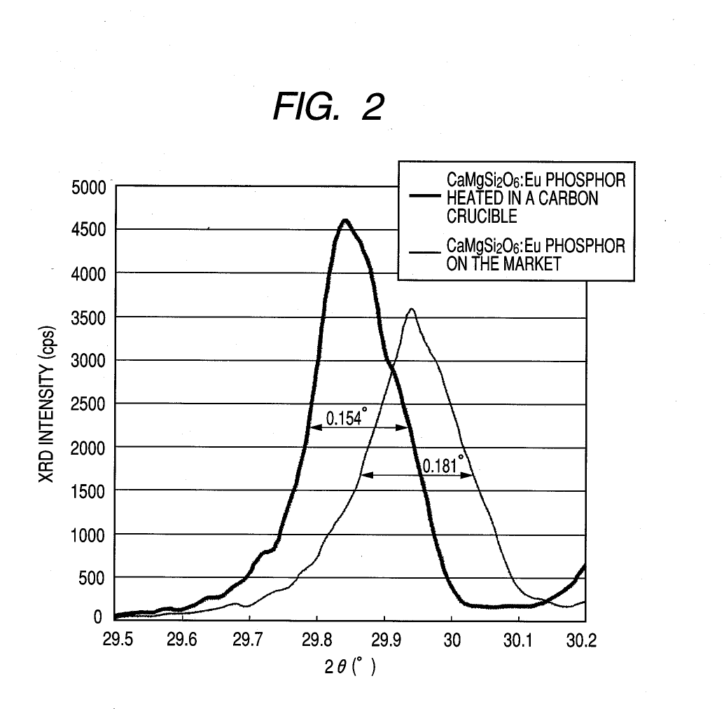

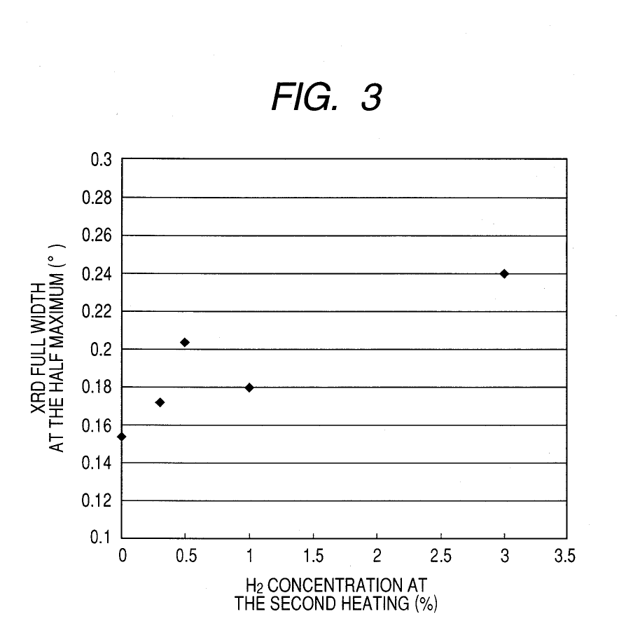

FIG. 1 is an X-ray diffraction drawing of a CaMgSi₂O₆:Eu blue emitting phosphor synthesized in a carbon crucible. X-ray diffraction of CaMgSi₂O₆ having a central peak at 29.8° is measured. X-ray diffraction peak of 29.8° is subjected to fitting by a Gaussian curve of expression 1 to obtain its full width at half maximum (FWHM). c(0), c(1), c(2), and c(3) in expression 1 are constants that decide the shape of the Gaussian curve, and c(3) is 2̂(½)σ (σ: standard deviation). FWHM at this time is determined by 2(2ln2)̂(½)σ=2.35σ. FIG. 2 is an enlarged view of X-ray diffraction. The full width at half maximum of a phosphor synthesized in a carbon crucible is 0.154°. This value is narrower than the full width at half maximum (0.181°) of X-ray diffraction peak of CaMgSi₂O₆:Eu blue emitting phosphor on the market, and it is confirmed that the crystallinity of phosphor synthesized in a carbon crucible is satisfactory. Next, X-ray diffraction of N₂—H₂ reducing atmosphere synthetic is measured. FIG. 3 shows the H2 concentration dependency of full width at half maximum of X-ray diffraction peak in an N₂—H₂ reducing atmosphere synthetic. At lower H₂ concentrations, full widths at half maximum are narrower and crystallinity are more satisfactory. Particularly, at less than H₂ concentration 0.5%, full widths at half maximum are narrow, and the crystallinity is satisfactory. (A phosphor heated in a carbon crucible is indicated by H₂ concentration 0%.)

f(x)=c(0)+c(1)exp(−((x−c(2))/c(3))⁻2) Expression 1

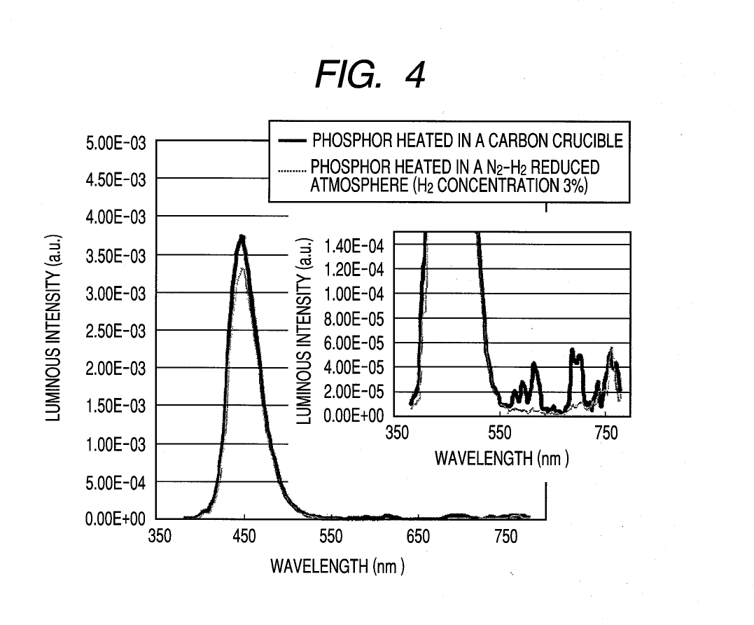

Next, luminescence spectrum of UV excitation of the synthesized CaMgSi₂O₆:Eu blue emitting phosphor is measured. Handy UV light is used as a UV excitation source. A phosphor sample is used with a phosphor packed in a sample holder of 1 mm in depth. The phosphor is excited by light of 254 nm, and the luminescence of the phosphor is measured by a luminance meter in a reflection side. Measurement results are shown in FIG. 4. In the phosphor heated in the carbon crucible, a red emitting component of Eu³⁺ develops at 620 nm. Its luminous intensity is 1% of blue luminous intensity of 448 nm. In a phosphor baked in N₂—H₂ atmosphere (H₂2 concentration 3%), a red emitting component does not develop, and the red emitting component is peculiar to phosphors heated in a carbon crucible. Since heating in a carbon crucible is performed in a weak reducing atmosphere, reduction from Eu³⁺ to Eu²⁺ is insufficient and an extremely small amount of Eu³⁺ remains. To increase the crystallinity of the CaMgSi₂O₆:Eu blue emitting phosphor, such a weak reducing atmosphere is proper.

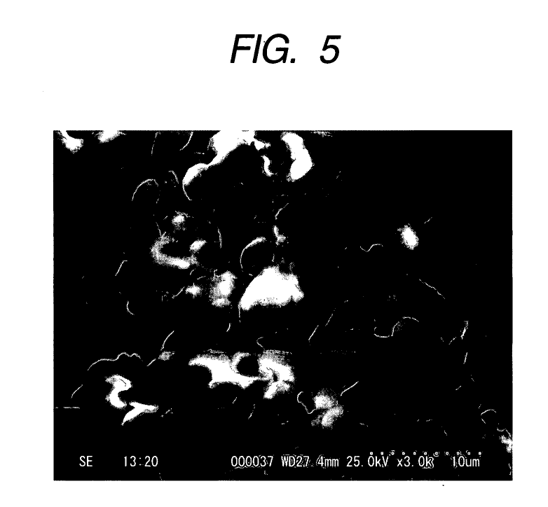

Next, SEM (Scanning Electron Microscope) of the synthesized CaMgSi₂O₆:Eu blue emitting phosphor is observed. FIG. 5 shows the SEM image of a phosphor synthesized in a carbon crucible. Phosphor particles having a particle diameter of about 3 to 8 μm are observed. The median diameter of the CaMgSi₂O₆:Eu blue emitting phosphors synthesized in the carbon crucible is 8 μm when measured by an instrument for measuring particle size distribution. Although the particle diameter of a used SiO₂ material is about 1 to 2 μm, it is observed that the phosphors crystal-grow by being synthesized in a weak reducing atmosphere. Such crystal growth is observed at less than H₂ concentration 0.5% in N₂—H₂ reducing atmosphere synthesis.

The median diameter of phosphors is measured by an instrument for measuring particle size distribution or directly observed by an electron microscope. For example, in the case of observation by an electron microscope, when the respective sections of variates of particle diameters of phosphors ( . . . , 0.8 to 1.2 μm, 1.3 to 1.7 μm, 1.8 to 2.2 μm, . . . , 6.8 to 7.2 μm, 7.3 to 7.7 μm, 7.8 to 8.2 μm, . . . , and so forth) are represented by class values xᵢ ( . . . , 1.0 μm, 1.5 μm, 2.0 μm, . . . , 7.0 μm, 7.5 μm, 8.0 μm, . . . ), and the frequencies of the variates observed by the electron microscope are indicated by fᵢ, a mean value M is represented as follows.

M=Σxᵢfᵢ/Σfⱼ=Σxⱼfᵢ/N Expression 2

In expression (2), Σfi=N. In this way, the median diameter of each phosphor can be found.

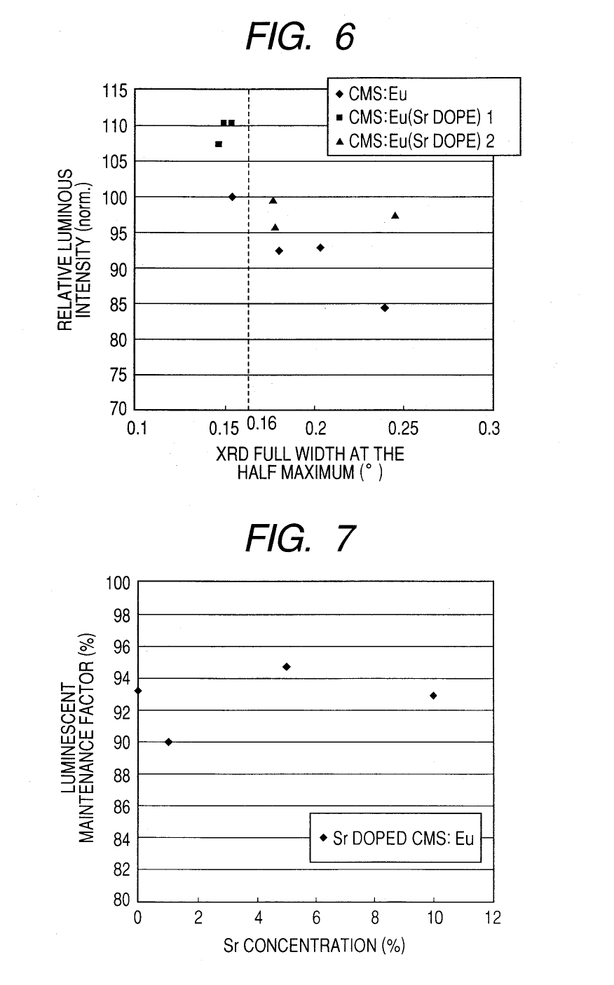

Next, electron beam exciting luminous intensity of the CaMgSi₂O₆:Eu blue emitting phosphor is evaluated. Each phosphor sample has a phosphor layer formed on a quartz substrate by the sedimentation method. A coating weight is 1 to 3 mg/cm². Produced samples are set in a demountable device equipped with an electron gun to perform measurement. Electron beams in the demountable device are scanned right and left, and up and down by a deflection yoke in the same frequency as that of general televisions, and draw a square raster (electron irradiation range) in a fixed range on the phosphor layers produced as described above. Luminous intensity is measured by using a color difference meter through an optical fiber from a penetration side. Luminescence property evaluation is performed under conditions of accelerating voltage 7 kV, irradiation area 20×10 mm, irradiation current 10 μA, current density 5 μA/cm², and sample temperature 20° C. Evaluation results are shown in FIG. 6. Narrower full widths at half maximum of X-ray diffraction peak and more satisfactory crystallinity tend to cause higher luminous intensity. Particularly, phosphors heated in a carbon crucible have satisfactory crystallinity of full width at half maximum of 0.16° or less and high luminous intensity. Furthermore, phosphor heated in a carbon crucible that are doped with the Sr element 1-10 wt. % have full widths at half maximum of 0.16° or less, and are about 10% higher in luminous intensity than phosphors not doped with the Sr element.

Next, a luminescent maintenance factor in electron irradiation of the CaMgSi₂O₆:Eu blue emitting phosphor is evaluated. A luminescent maintenance factor is evaluated using the above-described demountable device. A phosphor layer is formed on a Ni-plated Cu substrate by the sedimentation method to produce an evaluation sample. A coating weight is the same as that in the above-described luminescence evaluation. Luminous intensity is measured using a color difference meter and Si photo cells from the reflection side. To find a luminescent maintenance factor, an accelerated test is run under conditions of accelerating voltage 7 kV, irradiation area 6×6 mm, irradiation current 100 μA, current density 278 μA/cm², sample temperature 200° C., and measuring time of one hour. Evaluation results of luminescent maintenance factor are shown in FIG. 7. The luminescent maintenance factor of the ZnS:Ag phosphor is 80%, and the CaMgSi₂O₆:Eu blue emitting phosphor has a higher luminescent maintenance factor of 93%. The luminescent maintenance factor of the CaMgSi₂O₆:Eu blue emitting phosphor doped with 1 to 10% of Sr is almost the same as that of phosphors not doped with Sr.

The CaMgSi₂O₆:Eu blue emitting phosphor is produced as described above, and properties such as luminous intensity, luminescent maintenance factor, and full width at half maximum of X-ray diffraction are evaluated. As a result, it has become apparent that phosphors having been subjected to second heating in a weak reducing atmosphere such as phosphors heated in a carbon crucible have satisfactory crystallinity and high luminous intensity.

### Second Embodiment

MIM (Metal-Insulator-Metal) Type Electron Source Display 1

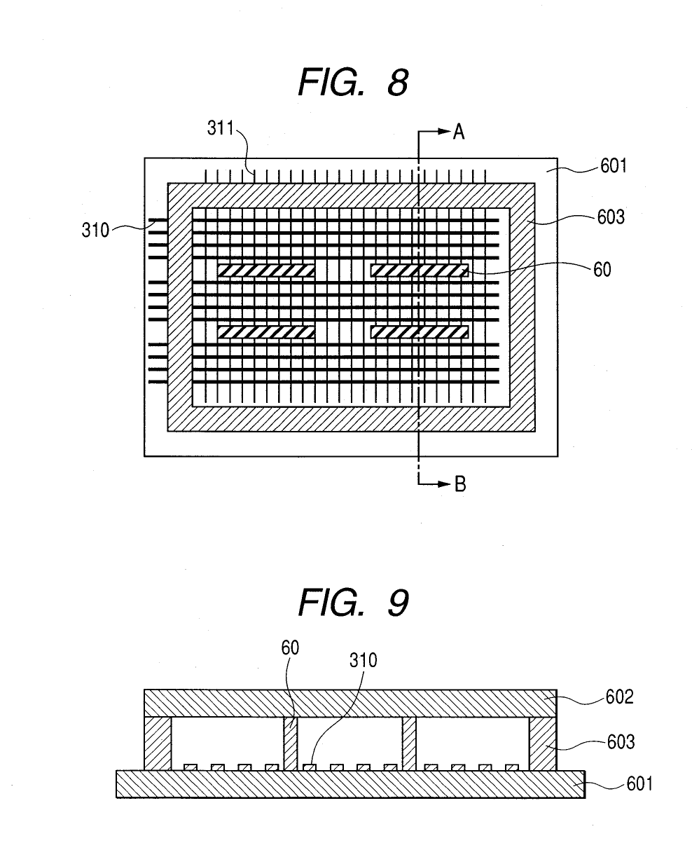

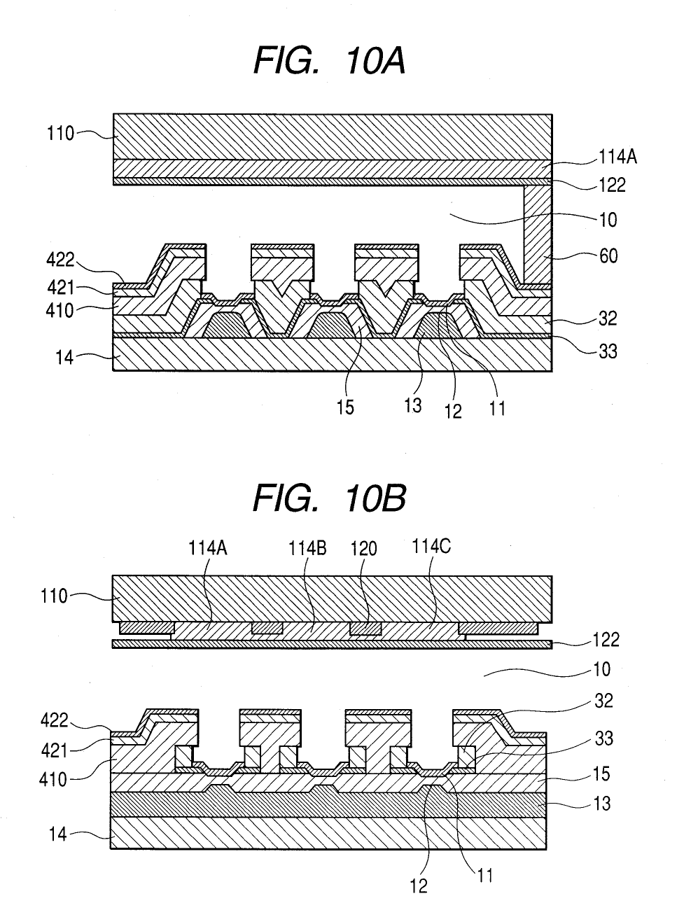

In this embodiment, a thin film electron source is used as an electron emitter 301. More specifically, a MIM electron source is used. FIG. 8 is a plan view of a display panel used in this embodiment. FIG. 9 is a sectional view of FIG. 8 taken along the line A-B. The inside enclosed by a cathode substrate 601, an anode substrate 602, and a frame 603 is vacuum. Spacers 60 are disposed in the vacuum region to resist atmospheric pressure. The shape, number, and disposition of the spacers 60 are arbitrary. Scanning electrodes 310 are horizontally disposed on the cathode substrate 601, and data electrodes 311 are disposed orthogonally to them. Intersections between the scanning electrodes 310 and the data electrodes 311 correspond to subpixels. The subpixels correspond to the respective subpixels of red, blue, and green in the case of a color display. Although only 12 scanning electrodes 310 are shown in FIG. 8, there are several hundreds to thousands of scanning electrodes in an actual display. The same is also true for the data electrodes 311. Electron emitters 301 are disposed in the intersections of the scanning electrodes 310 and the data electrodes 311. In this embodiment, thin film electron sources are used as the electron emitters 301. An electron emitter region exists in the region where the scanning electrodes 310 and the upper part electrode bus lines 32 intersect, and electrons are emitted from the region. FIG. 10 is a sectional view of the display panel used in this embodiment. FIG. 10A is a sectional view (for three subpixels) of FIG. 8 taken along the line A-B of FIG. 8. FIG. 10B is a sectional view (for three subpixels) in a direction orthogonal to it.

The structure of the cathode substrate 601 is as described below. On an insulating substrate 14 such as glass, a thin film electron source 301 comprising lower part electrodes 13 (Al), insulator layer 12 (Al₂O₃), and upper part electrodes 11 (Ir—Pt—Au) is formed. The upper part electrode bus lines 32 are electrically connected with the upper part electrodes 11 via upper part electrode bus line base films 33, and function as feeder lines to the upper part electrodes 11. In this embodiment, the upper part electrode bus lines 32 function as data electrodes 311. On the cathode substrate 601, a region (referred to as a cathode disposition region 610) in which the electron emitters 301 are disposed in a matrix form is covered with interlayer insulating films 410, on top of which common electrodes 420 is formed. The common electrodes 420 comprise multilayer films of common electrode films A 421 and common electrode films B 422. The common electrodes are connected to the ground potential. Spacers 60, which contact with the common electrodes 420, have a function to pass currents flowing via the spacers 60 from acceleration electrodes 122 of the anode substrate 602, and a function to pass electric charges charged in the spacers 60. In FIG. 10, the scale in the height direction is arbitrary. Specifically, the lower part electrodes 13, the upper part electrode bus lines 32, and the like have a width below several micrometers, while the distance between the substrate 14 and faceplate 110 is about 1 to 3 mm. A method of fabricating the cathode substrate 601 is described in JP-A No. 2003-323148.

Inside the anode substrate 602, there are phosphor layers 114A, 114B, and 114C formed by CaMgSi₂O₆:Eu blue emitting phosphor produced as in the first embodiment, Y₂SiO₅:Tb green emitting phosphor, and Y₂O₃:Eu red emitting phosphor. To increase resolution, a black conductive material is provided between pixels. In producing the black conductive material, a photoresist film is applied onto all the surfaces, and the black conductive material is exposed and developed via a mask to partially leave the photoresist film. Then, after forming a graphite film on all the surfaces, the black conductive material is formed by removing the photoresist film and graphite on it by making hydrogen peroxide and the like act. The phosphor layers are formed using the screen printing method. The phosphors are kneaded with vehicle based on cellulose resin and the like and prepared in a paste form. Next, they are pressed and applied via stainless meshes. The red, green, and blue phosphors are separately applied by aligning the positions of mesh holes with the positions of the respective phosphor layers. Next, mixed cellulose resins and the like are removed by heating the phosphor layers formed by printing. Thus, patterns of the phosphors are formed. The acceleration electrodes 122 (metal back) are produced by filming the inner surfaces of the phosphor layers and then vacuum-depositing aluminum. Then, filming agents are removed by performing a heating process. In this way, the anode substrate 602 is completed.

A proper number of the spacers 60 are disposed between the cathode substrate 601 and the anode substrate 602. As shown in FIGS. 8 and 9, the cathode substrate 601 and the anode substrate 602 are sealed across the frame 603. Furthermore, space 10 enclosed by the cathode substrate 601, the anode substrate 602, and the frame 603 is exhausted into a vacuum. In this way, the display panel 100 is completed.

Table 1 shows color temperatures of the display panel 100 when each CaMgSi₂O₆:Eu blue emitting phosphor is used. In a comparative example 1, CaMgSi₂O₆:Eu blue emitting phosphor (full width at half maximum 0.181°) on the market is used. The luminous efficiency of the blue phosphor in this case is 1.51 m/W, and color temperature at the time of combination with the red phosphor (Y₂O₃:Eu) and the green phosphor (Y₂SiO₅:Tb) is 6100K. Color temperatures of 9300K or more are required as the performance of a display panel. In the first embodiment, a CaMgSi₂O₆:Eu blue emitting phosphor having full widths at half maximum of X-ray diffraction peak of 0.16° or less is used. Color temperatures in this case are shown in the table. The luminous efficiency of the blue phosphor at this time is 2.1 1 m/W, and color temperature is 9300K. Thus, a display panel having satisfactory color temperatures can be produced by using a CaMgSi₂O₆:Eu blue emitting phosphor that is 0.16° or less in full widths at half maximum of X-ray diffraction peak and has satisfactory crystallinity and high luminous efficiency.

TABLE 1
Color temperatures of a display panel when each
CaMgSi₂O₆:Eu blue emitting phosphor is used

| | | | | Full width | | |
|---|---|---|---|---|---|---|
| | | | | at half | | |
| | | | | maximum of | | |
| | | | | blue | | |
| | | | | phosphor | Blue | Color |
| | | Green | Blue | X-ray | luminous | temperature |
| No. | Red phosphor | phosphor | phosphor | diffraction | efficiency | (K) |
| Comparative | Y₂O₃:Eu | Y₂SiO₅:Tb | CaMgSi₂O₆:Eu | 0.181 | 1.5 | 6100 |
| example 1 | | | | | | |
| First | Y₂O₃:Eu | Y₂SiO₅:Tb | CaMgSi₂O₆:Eu | <0.16 | 2.1 | 9300 |
| embodiment | | | | | | |

### Third Embodiment

### MIM Type Electron Source Display 2

FIG. 10 shows a MIM type electron source display of the present invention. Inside the anode substrate 602, there are phosphor layers 114A, 114B, and 114C formed by CaMgSi₂O₆:Eu blue emitting phosphor produced as in the first embodiment, ZnS:Cu,Al green emitting phosphor, and Y₂O₂S:Eu red emitting phosphor. A method of forming the phosphor layers, black conductive material, and metal back is the same as that in the second embodiment. Chromaticity by the present invention is particularly excellent.

### Fourth Embodiment

### MIM Type Electron Source Display 3

FIG. 10 shows a MIM type electron source display of the present invention. Inside the anode substrate 602, there are phosphor layers 114A, 114B, and 114C formed by a blue emitting phosphor consisting of a mixture of the CaMgSi₂O₆:Eu blue emitting phosphor produced as in the first embodiment and ZnS:Ag blue emitting phosphor, ZnS:Cu,Al green emitting phosphor, and Y₂O₃:Eu red emitting phosphor emitting phosphor. A method of forming the phosphor layers, black conductive material, and metal back is the same as that in the second embodiment. Luminous intensity by the present invention is particularly excellent.

### Fifth Embodiment

### MIM Type Electron Source Display 4

FIG. 10 shows a MIM type electron source display of the present invention. Inside the anode substrate 602, there are phosphor layers 114A, 114B, and 114C formed by (Ca,Sr)MgSi₂O₆:Eu blue emitting phosphor produced as in the first embodiment, Y₂SiO₅:Tb green emitting phosphor, and Y₂O₂S:Eu red emitting phosphor. A method of forming the phosphor layers, black conductive material, and metal back is the same as that in the second embodiment. Luminescence life and color temperature by the present invention are excellent.

### Fifth Embodiment

### MIM Type Electron Source Display 5

FIG. 10 shows a MIM type electron source display of the present invention. Inside the anode substrate 602, there are phosphor layers 114A, 114B, and 114C formed by CaMg(Si,Ge)₂O₆:Eu blue emitting phosphor produced as in the first embodiment, (Y,Gd)₂SiO₅:Tb green emitting phosphor, and Y₂O₃:Eu red emitting phosphor. A method of forming the phosphor layers, black conductive material, and metal back is the same as that in the second embodiment. Linearity and luminescence life by the present invention are excellent.

### Seventh Embodiment

### MIM Type Electron Source Display 6

FIG. 10 shows a MIM type electron source display of the present invention. Inside the anode substrate 602, there are phosphor layers 114A, 114B, and 114C formed by Ca(Mg,Zn)Si₂O₆:Eu blue emitting phosphor produced as in the first embodiment, ZnS:Cu,Al green emitting phosphor, and Y₂O₂S:Eu red emitting phosphor. A method of forming the phosphor layers, black conductive material, and metal back is the same as that in the second embodiment. Linearity and luminescence life by the present invention are excellent.

### Eighth Embodiment

### Display with Spindt Type Electron Source 1

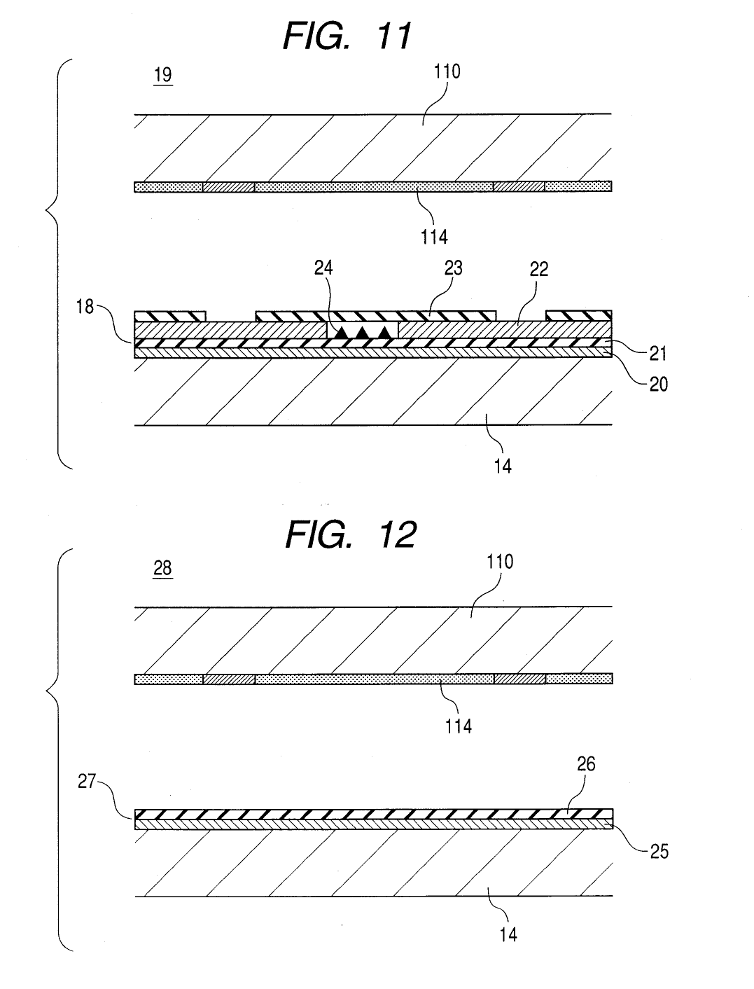

FIG. 11 shows a display with Spindt type electron source of the present invention. The display with Spindt type electron source 19 comprises a faceplate 110, a Spindt type electron source 18, and a rear plate 14. The Spindt type electron source 18 comprises a cathode 20, a resistance layer 21, an insulator layer 22, a gate 23, and a Spindt type electron emitter (Mo, etc.) 24. Inside the faceplate 110, there is a phosphor layer 114 formed by CaMgSi₂O₆:Eu blue emitting phosphor produced as in the first embodiment, Y₂SiO₅:Tb green emitting phosphor, and Y₂O₃: Eu red emitting phosphor. A method of forming the phosphor layers, black conductive material, and metal back is the same as that in the second embodiment. Luminous intensity, linearity, luminescence life, and colority by the present invention are excellent like the second embodiment.

A field-emission type electron source such as a Spindt type electron source suffers significant deterioration of electron emission performance when sulfur (element name: S) deposits on its surface. Therefore, by using combinations of phosphors containing no sulfur as in this embodiment, the long life and an improvement in the stability of electron emitters can be achieved.

### Ninth Embodiment

### Display with Spindt Type Electron Source 2

FIG. 11 shows a display with Spindt type electron source of the present invention. Inside the faceplate 110, there is a phosphor layer 114 formed by (Ca,Sr)MgSi₂O₆:Eu blue emitting phosphor produced as in the first embodiment, Y₂SiO₅:Tb green emitting phosphor, and Y₂O₂S: Eu red emitting phosphor. A method of forming the phosphor layers, black conductive material, and metal back is the same as that in the second embodiment. Luminous intensity, linearity, luminescence life, and colority balance by the present invention are excellent like the second embodiment.

### Tenth Embodiment

### Display with Spindt Type Electron Source 3

FIG. 11 shows a display with Spindt type electron source of the present invention. Inside the faceplate 110, there is a phosphor layer 114 formed by a blue emitting phosphor consisting of a mixture of CaMgSi₂O₆:Eu blue emitting phosphor produced as in the first embodiment and ZnS:Ag,Cl blue emitting phosphor, Y₂SiO₅:Tb green emitting phosphor, and a red emitting phosphor sample consisting of a mixture of Y₂O₂S:Eu and Y₂O₃:Eu red emitting phosphors. To lower the resistance of the phosphors, a conductive material In₂O₃ is mixed in the phosphor layer. A method of forming the phosphor layer, black conductive material, and metal back is the same as that in the second embodiment. Luminous intensity, linearity, luminescence life, and colority balance by the present invention are excellent like the second embodiment.

### Eleventh Embodiment

### Display with Carbon Nanotube Type Electron 1

FIG. 12 shows a display with carbon nanotube type electron. The display 28 with carbon nanotube type electron comprises a faceplate 110, a carbon nanotube type electron source 27, and a rear plate 14. The carbon nanotube type electron source 27 is formed from an electrode 25 and a carbon nanotube layer 26. Inside the faceplate 110, there is a phosphor layer 114 formed by CaMgSi₂O₆:Eu blue emitting phosphor produced as in the first embodiment, Y₂SiO₅:Tb green emitting phosphor, and Y₂O₃:Eu red emitting phosphor. A method of forming the phosphor layer, black conductive material, and metal back is the same as that in the second embodiment. Luminous intensity, linearity, luminescence life, and colority by the present invention are excellent like the second embodiment.

A field-emission type electron source such as the carbon nanotube type electron source suffers significant deterioration of electron emission performance when sulfur (element name: S) deposits on its surface. Therefore, by using combinations of phosphors containing no sulfur as in this embodiment, the long life and an improvement in the stability of electron emitters can be achieved.

### Twelfth Embodiment

### Display with Carbon Nanotube Type Electron 2

FIG. 12 shows a display with carbon nanotube type electron. Inside the faceplate 110, there is a phosphor layer 114 formed by (Ca, Sr)MgSi₂O₆:Eu blue emitting phosphor produced as in the first embodiment, Y₂SiO₅:Tb green emitting phosphor, and Y₂O₂S:Eu red emitting phosphor. A method of forming the phosphor layer, black conductive material, and metal back is the same as that in the second embodiment. Luminous intensity, linearity, luminescence life, and colority balance by the present invention are excellent like the second embodiment.

### Thirteenth Embodiment

### Display with Carbon Nanotube Type Electron 2

FIG. 12 shows a display with carbon nanotube type electron. Inside the faceplate 110, there is a phosphor layer 114 formed by a blue emitting phosphor consisting of a mixture of CaMgSi₂O₆:Eu blue emitting phosphor produced as in the first embodiment and ZnS:Ag,Al blue emitting phosphor, Y₂SiO₅:Tb green emitting phosphor, and a red emitting phosphor sample consisting of a mixture of Y₂O₂S:Eu and Y₂O₃:Eu red emitting phosphors. To lower the resistance of the phosphors, a conductive material In₂O₃ is mixed in the phosphor layer. A method of forming the phosphor layer, black conductive material, and metal back is the same as that in the second embodiment. Luminous intensity, linearity, luminescence life, and colority by the present invention are excellent like the second embodiment.

### Fourteenth embodiment

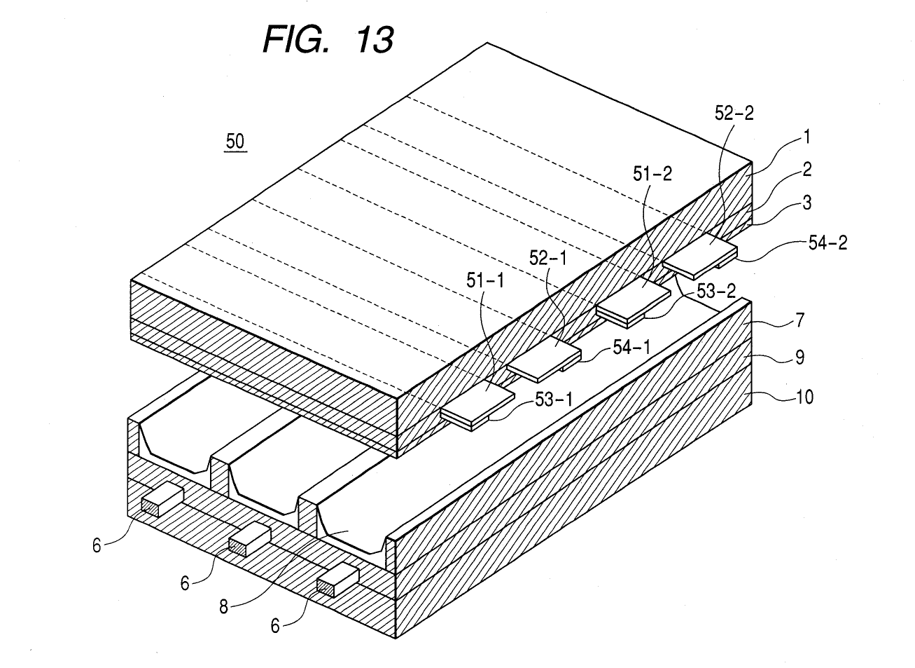

FIG. 13 shows a plasma display panel of the present invention. The plasma display panel 50 is structured so that a front substrate 1 is disposed to face a rear substrate 10. The plasma display panel 50 includes: barrier ribs 7 that are provided over the rear substrate 10 to hold a spacing between the pair of the substrates 1 and 10 when superposed; discharge gas (not shown) that is filled within a space formed between the pair of the substrates 1 and 10 and emits ultraviolet rays by discharge; and electrodes 51 and 52 disposed on the opposing faces of the pair of the substrates 1 and 10.

The CaMgSi₂O₆:Eu blue light emitting phosphor of the present invention constitutes phosphor layers 8 over one substrate 10 of the pair of the substrates and on the surface of the barrier ribs 7. Vacuum-ultraviolet rays having wavelengths of 146 nm and 172 nm emitted from the discharge gas by discharge excite the CaMgSi₂O₆:Eu blue light emitting phosphor constituting the phosphor layers 8 to emit visible light.

Table 2 shows results of evaluating luminous intensity by 172-nm excitation of the CaMgSi₂O₆:Eu blue light emitting phosphor produced as in the first embodiment. In phosphors doped with 5% of the Sr element, Br/y increases by 27%, compared with CaMgSi₂O₆:Eu blue light emitting phosphors on the market. Since the CaMgSi₂O₆:Eu blue light emitting phosphor of the present invention is narrow in full width at half maximum of X-ray diffraction and has satisfactory crystallinity, luminous intensity is high in vacuum ultraviolet excitation, as in the case of electron beam excitation.

TABLE 2
Luminous intensity of CaMgSi₂O₆:Eu blue light emitting
phosphor (172-nm excitation)

| | | Luminous | Relative | | | |
|---|---|---|---|---|---|---|
| | | intensity | luminous | | | Br/y |
| No | Sample | (cd/m2) | intensity | x | y | (relative value) |
| Second | Sr not doped | 26.00 | 122 | 0.153 | 0.047 | 126 |
| embodiment | | | | | | |
| Third | Sr doped (1%) | 26.06 | 122 | 0.143 | 0.049 | 121 |
| embodiment | | | | | | |
| Fourth | Sr doped (5%) | 28.36 | 133 | 0.154 | 0.051 | 127 |
| embodiment | | | | | | |
| Fifth | Sr doped | 23.14 | 109 | 0.156 | 0.053 | 99 |
| embodiment | (10%) | | | | | |
| Comparative | Commercially | 21.31 | 100 | 0.154 | 0.049 | 100 |
| example 2 | available product | | | | | |

In the plasma display panel 50, after address electrodes (electrodes 6) made of silver and the like, and a dielectric layer 9 made of a glass material are formed on the rear substrate (substrate 10), a barrier rib material made of a glass material is printed with a thick film, and the barrier ribs 7 are formed by blast removal using a blast mask. Next, on the barrier ribs 7, red, green, and blue phosphor layers 8 are successively formed in a stripe shape so as to clad groove faces between corresponding barrier ribs 7. Each phosphor layer 8 is coated by screen printing with a phosphor paste into which a corresponding phosphor powder and vehicle are mixed, and then formed by evaporating volatile components within the phosphor paste and removing organic substance within it by heating. As for materials of phosphors other than the blue light emitting phosphor, a red emitting phosphor is a (Y,Gd)BO₃:Eu phosphor, and a green emitting phosphor is a Zn₂SiO₄:Mn phosphor.

The front substrate (substrate 1) on which display electrodes (electrodes 51 and 52), bus lines 53 and 54, a dielectric layer 2, and a protective layer 3 are formed, and the rear substrate (substrate 10) are frit-sealed, the panel is evacuated, and then filled with discharge gas and sealed. The discharge gas has a composition ratio of 10% in terms of quantity and contains xenon (Xe) gas.

A plasma display has been produced which is constructed to display images in combination of the plasma display panel thus produced, and a driving circuit for driving the plasma display panel. The luminescence life of the produced display is excellent.

What is claimed is:

1. A display including a substrate including:
a plurality of first electrodes parallel to each other;
a plurality of second electrodes parallel to each other that are orthogonal to the first electrodes, and electron emitters disposed in intersections of the first electrodes and the second electrodes, or near the intersections; and
a faceplate on which phosphor layers are formed,
wherein, as the phosphor layers, blue emitting phosphor layers are used which contain CaMgSi₂O₆:Eu blue emitting phosphors that have 0.16° or less as full width at half maximum of an X-ray diffraction peak developing near a central peak of 29.8°.

2. A display including:
a substrate including a plurality of first electrodes parallel to each other;
a plurality of second electrodes parallel to each other that are orthogonal to the first electrodes, and electron emitters disposed in intersections of the first electrodes and the second electrodes, or near the intersections; and
a faceplate on which phosphor layers are formed, wherein, as the phosphor layers, blue emitting phosphor layers are used which contain CaMgSi₂O₆:Eu blue emitting phosphors in which a 620-nm red emitting component by Eu³⁺ exists at the time of excitation at 254 nm.

3. The display of claim 2,
wherein the red luminous intensity at 620 nm of the CaMgSi₂O₆:Eu blue emitting phosphors exists in a range from 0.3 to 2% with respect to blue luminous intensity at 448 nm.

4. The display of claim 1,
wherein the median diameter of the CaMgSi₂O₆:Eu blue emitting phosphors is from 5 to 8 μm.

5. The display of claim 1,
wherein blue emitting phosphor layers are used in which at least one kind of an element selected from a group comprising IIa, IIb, and IVb families is added to the CaMgSi₂O₆:Eu blue emitting phosphors.

6. The display of claim 1,
wherein blue emitting phosphor layers are used in which the Sr element is added to the CaMgSi₂O₆:Eu blue emitting phosphors.

7. The display of claim 1,
wherein addition amounts of the Sr element are from 1 to 10 wt. %.

8. The display of claim 1,
wherein the phosphors constituting the phosphor layers contain at least one kind of a trace impurity selected from a group comprising la and VIIb families, and rare-earth elements.

9. A method of manufacturing the display of claim 1, synthesizing the phosphors constituting the phosphor layers in a reducing atmosphere in which a carbon crucible is used.

10. A method of manufacturing the display of claim 1,
wherein H₂ concentration is less than 0.5% when the phosphors constituting the phosphor layers are synthesized in N₂—H₂ reducing atmosphere.

11. The display of claim 1,
wherein the accelerating voltages of electron beams emitted from the electron emitters to the phosphor layers are from 1 to 15 kV.

12. A display having a plasma display panel including a front substrate; and a rear substrate that are disposed in opposed relation, a plurality of display electrode pairs being disposed in parallel on the front substrate, and phosphor layers and a plurality of address electrodes disposed in a direction intersecting with the display electrode pairs being disposed in parallel on the rear substrate,
wherein, as the phosphor layers, blue emitting phosphor layers are used which contain CaMgSi₂O₆:Eu blue emitting phosphors that have 0.16° or less as full width at half maximum of an X-ray diffraction peak developing near a central peak of 29.8°.

13. A display having a plasma display panel including:
a front substrate and a rear substrate that are disposed in opposed relation, a plurality of display electrode pairs being disposed in parallel on the front substrate, and phosphor layers and a plurality of address electrodes disposed in a direction intersecting with the display electrode pairs being disposed in parallel on the rear substrate,
wherein, as the phosphor layers, blue emitting phosphor layers are used which contain CaMgSi₂O₆:Eu blue emitting phosphors in which red luminous intensity at 620 nm exists in a range from 0.3 to 2% with respect to blue luminous intensity at 448 nm at the time of excitation at 254 nm.
